(19) United States
(12) Patent Application Publication
(10) Pub. No.: US 2015/0251065 A1
(43) Pub. Date: Sep. 10, 2015

(54) FRONT WHEEL QUICK-RELEASE DEVICE FOR GOLF CART

(71) Applicant: SPORTS WORLD ENTERPRISE CO., LTD., Tainan City (TW)

(72) Inventor: FANG-LI WU, TAINAN CITY (TW)

(73) Assignee: SPORTS WORLD ENTERPRISE CO., LTD., Tainan City (TW)

(21) Appl. No.: 14/202,133

(22) Filed: Mar. 10, 2014

(51) Int. Cl. A63B 55/08; B62B 3/02

(52) U.S. Cl. CPC A63B 55/08; B62B 3/02

(57) ABSTRACT

A front wheel quick-release device of a golf cart includes a golf cart frame having a front wheel unit connected thereto. The front wheel unit has a connection tube and two rods extending from the connection tube. The golf cart frame has a tubular portion which has an engaging slot, and two guide slots are defined through two sidewalls of the tubular portion and communicate with the engaging slot. The connection tube is directly inserted into the engaging slot and the two rods movably extend through the guide slots to easily connect or replace the front wheel unit.

### BACKGROUND OF THE INVENTION

1. Fields of the Invention

The present invention relates to a front wheel quick-release device, and more particularly, to a front wheel quick-release device of a golf cart wherein the front wheel unit is directly connected to the golf cart frame.

2. Descriptions of Related Art

The conventional golf cart is designed to carry the golf clubs which are heavy and have different sizes and lengths. The golf clubs are put in a golf bag and the golf cart has a reception area for positioning the golf bag. The players move the golf cart easily and conveniently. In order to save the space required, some of the conventional golf carts are foldable.

One of the conventional golf cart is disclosed in Taiwan Utility Model No. M342872 and comprises a front wheel unit and an axle of the front wheel unit. The front wheel unit has a hollow sleeve which has a stop flange on the distal end thereof. A polygonal positioning portion is formed behind the stop flange and a rotary member is located behind the polygonal positioning portion. The axle is connected to the front wheel and has a shaft to which a resilient member is mounted. The shaft and the resilient member are then inserted into the sleeve. The distal end of the shaft is fixed to the sleeve. The shaft has a positioning member which has a polygonal reception portion which is located corresponding to the polygonal positioning portion. A space for rotation is formed behind the reception portion.

However, the front wheel needs to be replaced according to the load and the travel paths conditions, and the front wheel of the golf cart cannot be replaced. Besides, the folded golf cart still occupies too much space.

The present invention intends to provide a front wheel quick-release device of a golf cart to improve the shortcomings mentioned above.

### SUMMARY OF THE INVENTION

The present invention relates to a front wheel quick-release device of a golf cart, and comprises a golf cart frame having a front wheel unit connected thereto. The front wheel unit has a pivot member which is pivotably connected to at least one front wheel. The pivot member has a connection tube and two rods extend from the connection tube. The golf cart frame has a tubular portion which has an engaging slot. Two guide slots are defined through two sidewalls of the tubular portion and communicate with the engaging slot. The connection tube is inserted into the engaging slot and the two rods movably extend through the guide slots.

Preferably, an insertion is inserted into the connection tube and has a protrusion extending from the inside of the first end thereof. A hole is defined through the second end of the insertion and located corresponding to the protrusion. An end piece movably extends through the hole. A resilient member is connected between the protrusion and the end piece. The resilient member provides a buffering force when the connection tube is inserted into the engaging slot. When the front wheel unit is separated from the golf cart, the resilient member bounces the insertion together with the connection tube away from the tubular portion of the golf cart frame.

The primary object of the present invention is to provide a front wheel quick-release device of a golf cart, and the front wheel unit can be connected to the golf cart frame by directly inserting the connection tube of the front wheel unit to the engaging slot of the golf cart frame.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the golf cart with the front wheel unit of the present invention connected thereto;

FIG. 2 is an exploded view to show the front wheel unit of the present invention;

FIG. 3 is a perspective view, from the underside, to show the golf cart with the front wheel unit of the present invention connected thereto;

FIG. 4 is a cross sectional view of the connection of the front wheel unit of the present invention and the golf cart frame;

FIG. 5 is a cross sectional view to show that the front wheel unit of the present invention is separated from the golf cart frame, and

FIG. 6 is an exploded view to show the front wheel unit with two front wheels of the present invention.

### DETAILED DESCRIPTION OF THE PREFERRED EMBODIMENT

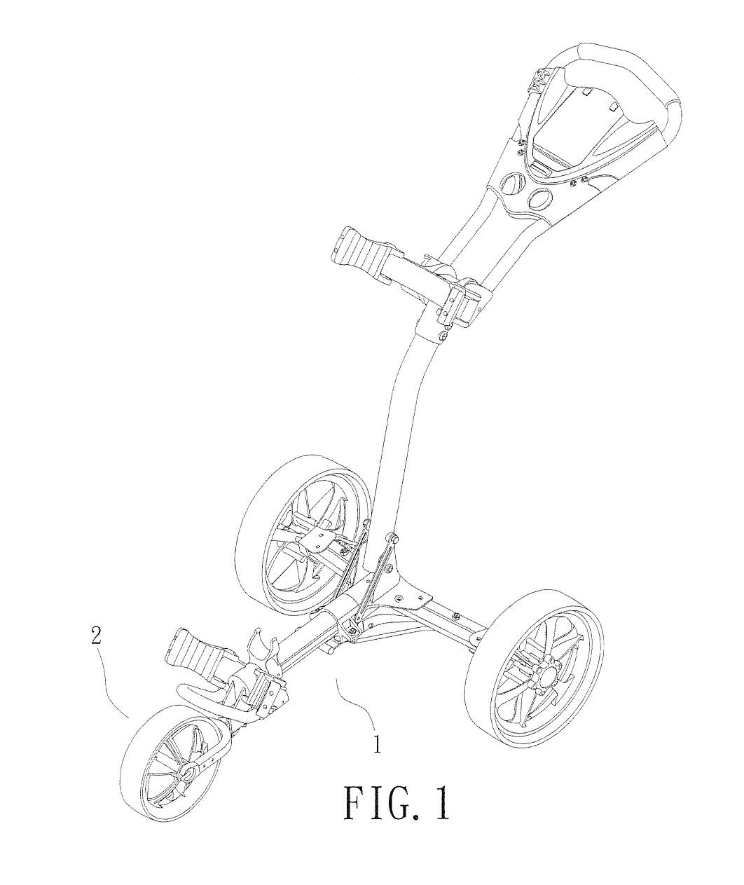

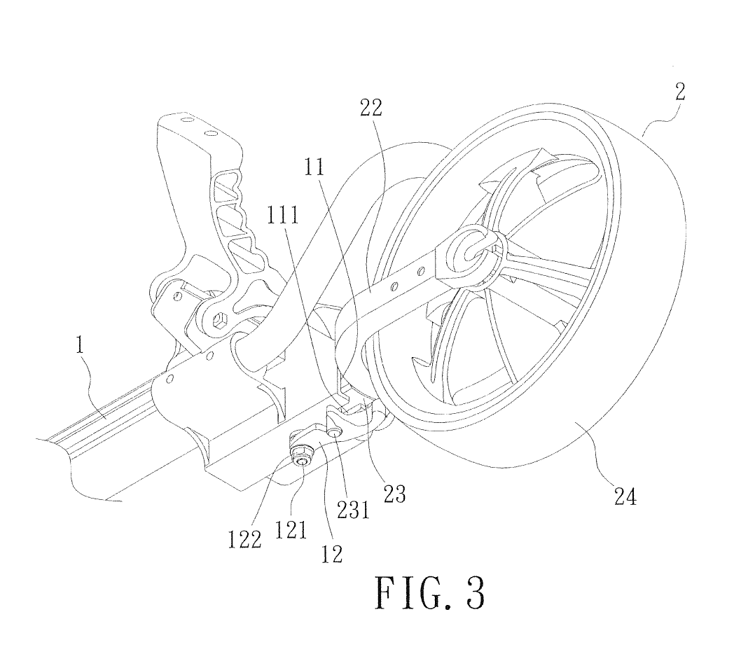

Referring to FIGS. 1 to 3, a front wheel quick-release device of a golf cart comprises a golf cart frame 1 having a front wheel unit 2 connected to the front end thereof.

The front wheel unit 2 comprises a pivot member 22 which is pivotably connected to at least one front wheel 21. The pivot member 22 has a connection tube 23 and two rods 231 extend from the connection tube 23.

The golf cart frame 1 has a tubular portion which has an engaging slot 11, and two guide slots 111 are defined through two sidewalls of the tubular portion and communicate with the engaging slot 11. The connection tube 23 is inserted into the engaging slot 11 and the two rods 231 movably extend through the guide slots 111. A locking member 12 is located on outside of the tubular portion to restrict the rod 231 from disengaging from the guide slot 111.

An insertion 24 is inserted into the connection tube 23 and has a protrusion 241 extending from the inside of the first end thereof, and a hole 242 is defined through the second end of the insertion 24 and located corresponding to the protrusion 241. An end piece 25 movably extends through the hole 242. A resilient member 26 is connected between the protrusion 241 and the end piece 25. The resilient member 26 provides a buffering force when the connection tube 23 is inserted into the engaging slot 11.

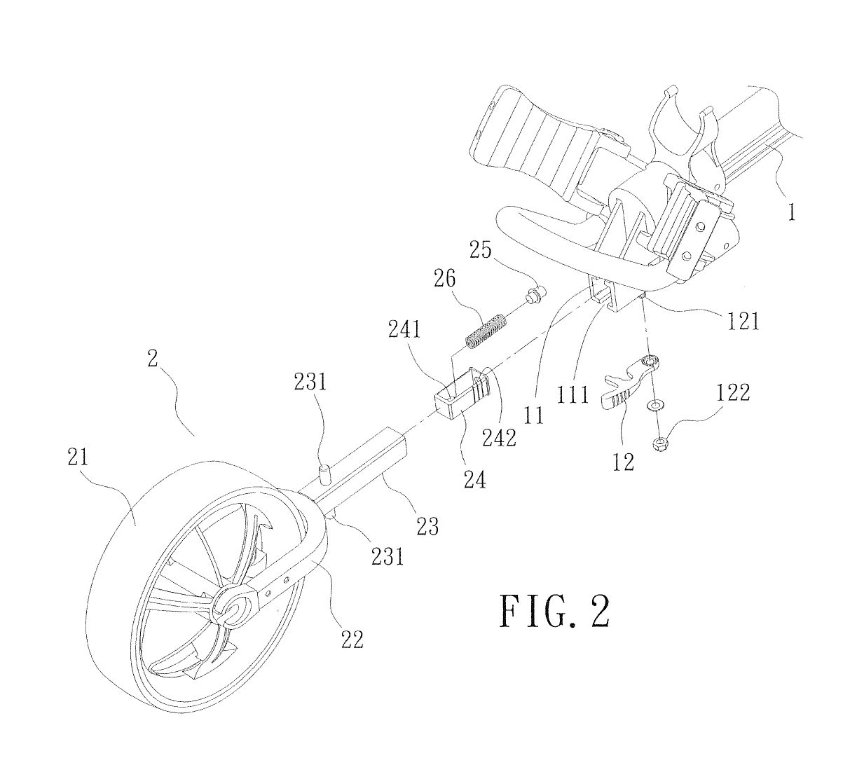

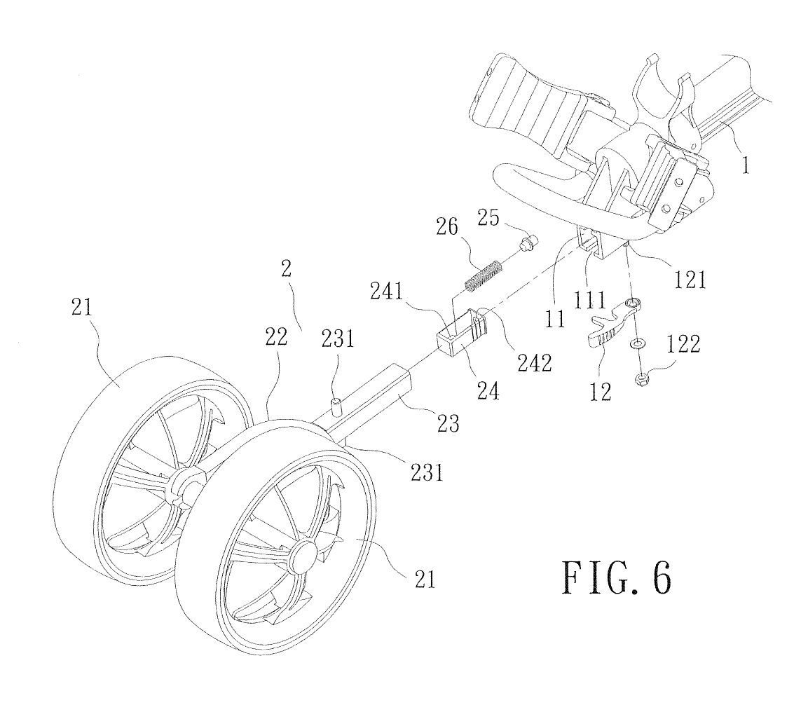

As shown in FIGS. 1 to 6, the pivot member 22 is pivotably connected to the at least one front wheel 21 as shown in FIGS. 2 and 6. The two rods 231 preferably extend from two opposite sides of the connection tube 23, and the two guide slots 111 are defined through two opposite sidewalls of the tubular portion, so that the connection tube 23 can be easily inserted into the engaging slot 11 and does not shake. The locking member 12 is pivotably connected to the outside of the tubular portion. A threaded bolt 121 extends from the tubular portion and is connected to the locking member 12, a nut 122 is connected to the bolt 121 to position the locking member 12 which is able to rotated to let the notch of the locking member 12 be away from the rod 231.

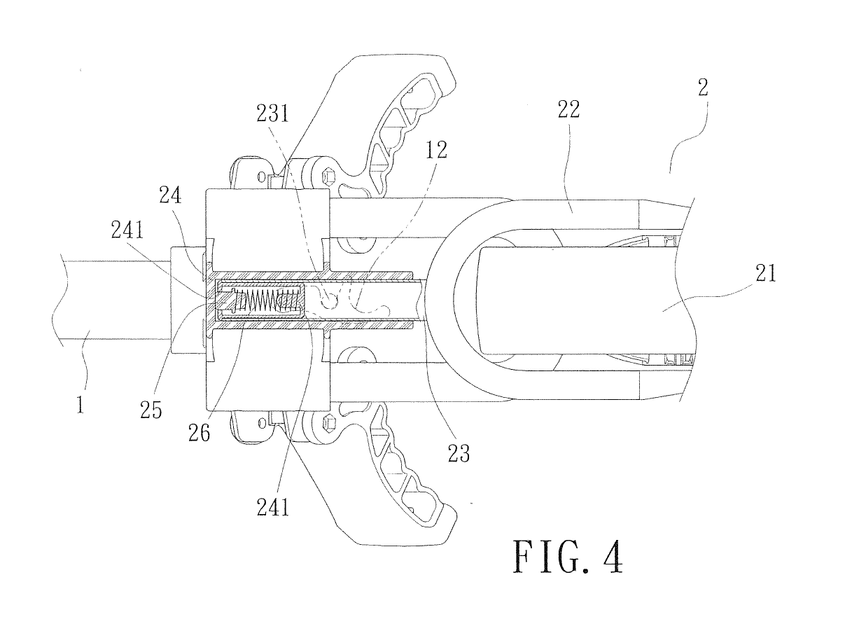

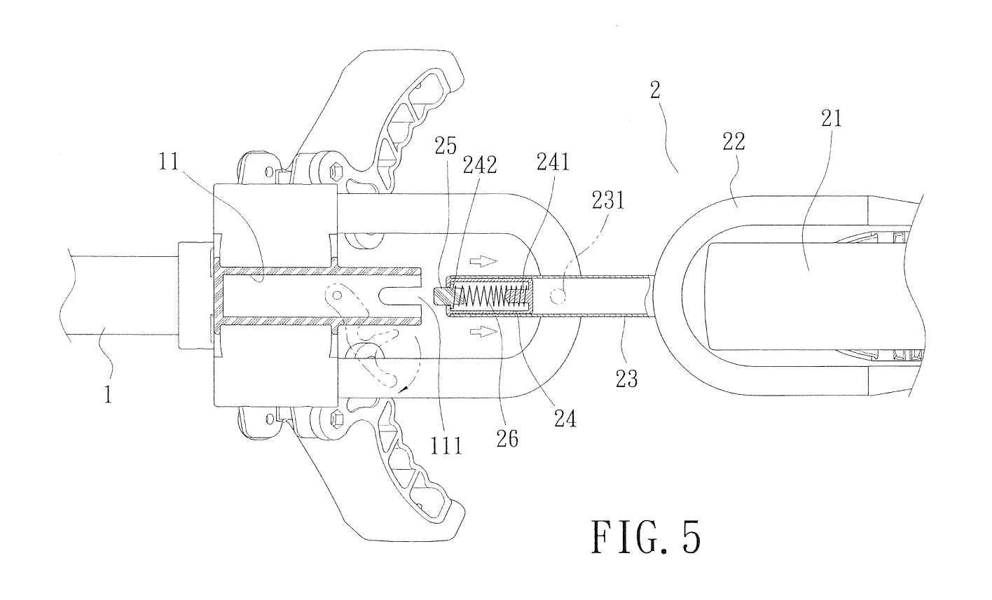

As shown in FIGS. 4 and 5, when the connection tube 23 reaches the end of the engaging slot 11, the end piece 25 contacts the inner end of the engaging slot 11 to compress the resilient member 26 which provides a buffering force and the user is acknowledged that the connection tube 23 reaches the position. The locking member 12 is then locks the rod 231 to secure the front wheel unit 2 to the golf cart frame 1.

When the front wheel unit 2 is to be replaced, the locking member 12 is pivoted and the resilient member 26 pushes the connection tube 23 away so that the user can easily separate the front wheel unit 2 from the golf cart frame 1.

The advantages of the present invention are that the connection tube 23 can be easily and directly inserted into the engaging slot 11 to quickly install or remove the front wheel unit 2 to or from the golf cart frame 1.

The connection tube 23 has two rods 231 extending from two different directions so that the user can insert the connection tube 23 into the engaging slot 11 regardless of which side of the connection tube 23 facing upward.

The resilient member 26 provides a buffering force when the connection tube 23 is inserted into the engaging slot 11. When the front wheel unit 2 is separated from the golf cart, the resilient member 26 bounces the connection tube 23 away from the tubular portion of the golf cart frame 1.

While we have shown and described the embodiment in accordance with the present invention, it should be clear to those skilled in the art that further embodiments may be made without departing from the scope of the present invention.

What is claimed is:

1. A front wheel quick-release device of a golf cart, comprising:
a golf cart frame having a front wheel unit connected thereto, the front wheel unit having a pivot member which is pivotably connected to at least one front wheel, the pivot member having a connection tube and two rods extending from the connection tube, and
the golf cart frame having a tubular portion with an engaging slot, two guide slots defined through two sidewalls of the tubular portion and communicating with the engaging slot, and a locking member located outside of the tubular portion; wherein the connection tube is inserted into the engaging slot and the two rods are movably extended through the guide slots.

2. The device as claimed in claim 1, wherein an insertion is inserted into the connection tube and has a protrusion extending from an inside of a first end thereof, a hole is defined through a second end of the insertion and located corresponding to the protrusion, an end piece movably extends through the hole, a resilient member is connected between the protrusion and the end piece.

3. The device as claimed in claim 1, wherein the two rods extend from two opposite sides of the connection tube, the two guide slots are defined through two opposite sidewalls of the tubular portion.

4. The device as claimed in claim 2, wherein the two rods extend from two opposite sides of the connection tube, the two guide slots are defined through two opposite sidewalls of the tubular portion.
